(19) United States
(12) Patent Application Publication
(10) Pub. No.: US 2014/0255702 A1
(43) Pub. Date: Sep. 11, 2014

(54) ELECTRODEPOSITABLE FILM-FORMING COMPOSITIONS CAPABLE OF FORMING STRATIFIED FILMS, AND THEIR USE IN COMPACT PROCESSES

(71) Applicant: PPG INDUSTRIES OHIO, INC., Cleveland, OH (US)

(72) Inventors: Ellor James Van Buskirk, Pittsburgh, PA (US); Craig A. Wilson, Allison Park, PA (US); Richard F. Karabin, Ruffs Dale, PA (US)

(73) Assignee: PPG INDUSTRIES OHIO, INC., Cleveland, OH (US)

(21) Appl. No.: 13/784,858

(22) Filed: Mar. 5, 2013

(51) Int. Cl. C09D 5/44; C25D 13/04

(52) U.S. Cl. CPC C09D 5/4473; C25D 13/04
USPC 428/418; 204/488; 523/427

(57) ABSTRACT

An electrodepositable film-forming composition is provided, comprising a resinous phase dispersed in an aqueous medium. The resinous phase comprises: (1) an ungelled active hydrogen-containing, cationic resin derived from a polyepoxide; (2) a cationic acrylic resin containing urethane functional groups; and (3) an at least partially blocked polyisocyanate curing agent. Also provided is a coated metal substrate comprising: A) a metal substrate having at least one coatable surface, and B) a cured coating layer deposited on at least one surface of the substrate and having a coating/air interface and a coating/substrate interface, wherein the cured coating layer is deposited from the electrodepositable film-forming composition described above. Further provided is a process for coating an electroconductive substrate, comprising electrophoretically depositing on the substrate the curable, electrodepositable coating composition described above.

### FIELD OF THE INVENTION

The present invention relates to electrodepositable film-forming compositions, coated substrates, and methods of forming multi-component composite coatings on substrates using compact (wet-on-wet) processes.

### BACKGROUND OF THE INVENTION

In industrial coating processes such as those used in automotive manufacturing, efforts are constantly made to reduce energy consumption and costs, as well as atmospheric pollution caused by volatile solvents which are emitted during a painting process. However, it is often difficult to achieve high quality, smooth coating finishes, such as are required in the automotive industry, without using organic solvents in the paint compositions. Solvents improve the flow and leveling of a coating during application to a substrate, thereby improving the coating's final appearance. It is also difficult to provide adequate physical properties without applying multiple coating layers, each having their own cure regimen. In addition to achieving near-flawless appearance, automotive coatings must be durable and chip resistant, historically made possible by using multiple coating layers, each serving its own purpose.

The current state of the art automobile painting process involves electrophoretic application of a paint layer to the bare or treated metal substrate followed by fully curing the so-applied layer. A primer layer, whose purpose is primarily to provide chip resistance, UV opacity, and substrate filling (to smooth surface defects) is then applied, followed again by a full curing cycle. A colored basecoat layer is then applied, generally followed by a heated flash and then application of a final clearcoat layer. These two layers are then co-cured to produce the final coated article. There has been a tendency in the last decade to reduce the paint booth footprint, reduce the number of intermediate bake cycles and hence energy expenditure, reduce the number of coating layers and therefore system complexity, while maintaining the high level of optical quality and appearance of the resulting coated vehicles. The general name given to such modified paint processes is Compact Process.

In order to reduce layers, it is usually the primer layer and its associated oven that is eliminated, and the basecoat composition is then typically designed to incorporate some of the primer properties such as chip resistance and substrate filling. In this case the basecoat is typically applied in two layers with the composition of the first layer being modified to incorporate some heretofore primer-associated properties. After application of the two basecoat layers, a heated flash may be employed to remove some of the solvent and is followed by clear coat application. The multi-component composite coating composition, or “coating stack”, is then co-cured to provide the final article. In order to provide desired basecoat opacity and protection of the electrocoat layer, the sum of basecoat layer thicknesses is generally greater than the thickness of a basecoat applied over a fully baked conventional primer.

The use of a thicker base coat layer is not always feasible and in the absence of a primer layer and its attendant properties including UV opacity, chip resistance, and GALVANNEAL splitting resistance, system drawbacks such as delamination, chipping, chalking, and poor color control can result.

Compact Coating systems that provide the desired physical and optical quality levels over a range of intermediate flash conditions are needed in order to accommodate the different processing parameters of different manufacturers. The system must also be designed to guarantee appearance consistency and quality at different locations on the same vehicle, which may undergo different process conditions during coating. For these reasons, it is desired to develop resins and coating compositions that provide coating system versatility and coating quality in a Compact Process, effectively eliminating the need for a primer-surfacer.

### SUMMARY OF THE INVENTION

The present invention is directed to an electrodepositable film-forming composition. The film-forming composition comprises a resinous phase dispersed in an aqueous medium. The resinous phase comprises:
(1) an ungelled active hydrogen-containing, cationic resin derived from a polyepoxide;
(2) a cationic acrylic resin containing urethane functional groups; and
(3) an at least partially blocked polyisocyanate curing agent.

The cationic acrylic resin (2) comprises one of two alternatives, depending on how it is prepared; either (A) a reaction product of a reaction mixture comprising: (i) an acrylic resin having functional groups that are reactive with amines and (ii) a urethane functional amine compound, or (B) a polymerization product of a monomer mixture, wherein the monomer mixture contains an ethylenically unsaturated reaction product of a reaction mixture comprising: (i) an ethylenically unsaturated monomer having functional groups that are reactive with amines and (ii) a urethane functional amine compound. In either scenario, the urethane functional amine compound comprises a reaction product of a reaction mixture comprising (a) a polyamine having at least one primary amino group and at least one secondary amino group; and (b) a cyclic carbonate.

The present invention is further drawn to a coated metal substrate comprising:
A) a metal substrate having at least one coatable surface, and
B) a cured coating layer deposited on at least one surface of the substrate and having a coating/air interface and a coating/substrate interface, wherein the cured coating layer is deposited from the electrodepositable film-forming composition described above. The cationic acrylic resin in the film-forming composition is concentrated at the coating/air interface and the cationic resin derived from a polyepoxide is concentrated at the coating/substrate interface.

The present invention is further drawn to a process for coating an electroconductive substrate. The process comprises:

(a) electrophoretically depositing on the substrate the curable, electrodepositable coating composition described above to form an electrodeposited coating over at least a portion of the substrate;

(b) heating the coated substrate to a temperature and for a time sufficient to cure the electrodeposited coating on the substrate;

(c) applying directly to the cured electrodeposited coating a first coating composition to form a top coat over at least a portion of the cured electrodeposited coating;

(d) applying a second coating composition to at least a portion of the first coating formed in step (c) prior to substantially curing the first coating, to form a secondary top coat thereon;

(e) heating the coated substrate formed in step (d) to a temperature and for a time sufficient to cure all the top coats.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

The various embodiments and examples of the present invention as presented herein are each understood to be non-limiting with respect to the scope of the invention.

As used in the following description and claims, the following terms have the meanings indicated below:

The term “curable”, as used for example in connection with a curable composition, means that the indicated composition is polymerizable or cross linkable through functional groups, e.g., by means that include, but are not limited to, thermal (including ambient cure) and/or catalytic exposure.

The term “cure”, “cured” or similar terms, as used in connection with a cured or curable composition, e.g., a “cured composition” of some specific description, means that at least a portion of the polymerizable and/or crosslinkable components that form the curable composition is polymerized and/or crosslinked. Additionally, curing of a composition refers to subjecting said composition to curing conditions such as but not limited to thermal curing, leading to the reaction of the reactive functional groups of the composition, and resulting in polymerization and formation of a polymerizate. When a polymerizable composition is subjected to curing conditions, following polymerization and after reaction of most of the reactive end groups occurs, the rate of reaction of the remaining unreacted reactive end groups becomes progressively slower. The polymerizable composition can be subjected to curing conditions until it is at least partially cured. The term “at least partially cured” means subjecting the composition to curing conditions, wherein reaction of at least a portion of the reactive groups of the composition occurs, to form a polymerizate.

As used herein, “substantially uncured” means that the coating composition, after application to the surface of a substrate, forms a film which is substantially uncrosslinked; i.e., it is not heated to a temperature sufficient to induce significant crosslinking and there is substantially no chemical reaction between the polymeric component and the curing agent.

The term “reactive” refers to a functional group capable of undergoing a chemical reaction with itself and/or other functional groups spontaneously or upon the application of heat or in the presence of a catalyst or by any other means known to those skilled in the art.

By “polymer” is meant a polymer including homopolymers and copolymers, and oligomers. By “composite material” is meant a combination of two or more different materials.

The resinous phase of the film-forming composition of the present invention comprises three components. The first (1) is an ungelled active hydrogen-containing, cationic resin derived from a polyepoxide. Suitable polyepoxides polymers for use as the active hydrogen-containing, cationic salt group-containing resin include, for example, a polyepoxide chain-extended by reacting together a polyepoxide and a polyhydroxyl group-containing material such as alcoholic hydroxyl group-containing materials and phenolic hydroxyl group-containing materials to chain extend or build the molecular weight of the polyepoxide.

A chain-extended polyepoxide is typically prepared by reacting together the polyepoxide and polyhydroxyl group-containing material neat or in the presence of an inert organic solvent such as a ketone, including methyl isobutyl ketone and methyl amyl ketone, aromatics such as toluene and xylene, and glycol ethers such as the dimethyl ether of diethylene glycol. The reaction is usually conducted at a temperature of about 80° C. to 160° C. for about 30 to 180 minutes until an epoxy group-containing resinous reaction product is obtained.

The equivalent ratio of reactants; i.e., epoxy:polyhydroxyl group-containing material is typically from about 1.00:0.75 to 1.00:2.00.

The polyepoxide by definition has at least two 1,2-epoxy groups. In general the epoxide equivalent weight of the polyepoxide will range from 100 to about 2000, typically from about 180 to 500. The epoxy compounds may be saturated or unsaturated, cyclic or acyclic, aliphatic, alicyclic, aromatic or heterocyclic. They may contain substituents such as halogen, hydroxyl, and ether groups.

Examples of polyepoxides are those having a 1,2-epoxy equivalency greater than one and usually about two; that is, polyepoxides which have on average two epoxide groups per molecule. The most commonly used polyepoxides are polyglycidyl ethers of cyclic polyols, for example, polyglycidyl ethers of polyhydric phenols such as Bisphenol A, resorcinol, hydroquinone, benzenedimethanol, phloroglucinol, and catechol; or polyglycidyl ethers of polyhydric alcohols such as alicyclic polyols, particularly cycloaliphatic polyols such as 1,2-cyclohexane diol, 1,4-cyclohexane diol, 2,2-bis(4-hydroxycyclohexyl)propane, 1,1-bis(4-hydroxycyclohexyl)ethane, 2-methyl-1,1-bis(4-hydroxycyclohexyl)propane, 2,2-bis(4-hydroxy-3-tertiarybutylcyclohexyl)propane, 1,3-bis(hydroxymethyl)cyclohexane and 1,2-bis(hydroxymethyl)cyclohexane. Examples of aliphatic polyols include, inter alia, trimethylpentanediol and neopentyl glycol.

Polyhydroxyl group-containing materials used to chain extend or increase the molecular weight of the polyepoxide may additionally be polymeric polyols.

The resins (1) used in the electrodepositable composition typically have number average molecular weights ranging from about 180 to 500, often from about 186 to 350.

The resin (1) used in the composition of the present invention contains cationic salt groups. The cationic salt groups may be incorporated into the resin by reacting epoxide groups in the resin with a cationic salt group former. By “cationic salt group former” is meant a material which is reactive with epoxy groups and which can be acidified before, during, or after reaction with epoxy groups to form cationic salt groups. Examples of suitable materials include amines such as primary or secondary amines which can be acidified after reaction with the epoxy groups to form amine salt groups, or tertiary amines which can be acidified prior to reaction with the epoxy groups and which after reaction with the epoxy groups form quaternary ammonium salt groups. Examples of other cationic salt group formers are sulfides that can be mixed with acid prior to reaction with the epoxy groups and form ternary sulfonium salt groups upon subsequent reaction with the epoxy groups.

When amines are used as the cationic salt formers, monoamines are often used, and hydroxyl-containing amines are particularly suitable. Polyamines may be used but are not recommended because of a tendency to gel the resin.

In a typical embodiment of the invention, the cationic salt group-containing resin contains amine salt groups, which are derived from an amine containing a nitrogen atom to which is bonded at least one, usually two, alkyl groups having a hetero atom in a beta-position relative to the nitrogen atom. A hetero atom is a non-carbon or non-hydrogen atom, typically oxygen, nitrogen, or sulfur.

Hydroxyl-containing amines, when used as the cationic salt group formers, may impart the resin with amine groups comprising a nitrogen atom to which is bonded at least one alkyl group having a hetero atom in a beta-position relative to the nitrogen atom. Examples of hydroxyl-containing amines are alkanolamines, dialkanolamines, alkyl alkanolamines, and aralkyl alkanolamines containing from 1 to 18 carbon atoms, usually 1 to 6 carbon atoms in each of the alkanol, alkyl and aryl groups. Specific examples include ethanolamine, N-methylethanolamine, diethanolamine, N-phenylethanolamine, N,N-dimethylethanolamine, N-methyldiethanolamine, triethanolamine and N-(2-hydroxyethyl)-piperazine.

Minor amounts of amines such as mono, di, and trialkylamines and mixed aryl-alkyl amines which do not contain hydroxyl groups, or amines substituted with groups other than hydroxyl which do not negatively affect the reaction between the amine and the epoxy may also be used, but their use is not preferred. Specific examples include ethylamine, methylethylamine, triethylamine, N-benzyldimethylamine, dicocoamine and N,N-dimethylcyclohexylamine.

The reaction of a primary and/or secondary amine with epoxide groups on the polymer takes place upon mixing of the amine and polymer. The amine may be added to the polymer or vice versa. The reaction can be conducted neat or in the presence of a suitable solvent such as methyl isobutyl ketone, xylene, or 1-methoxy-2-propanol. The reaction is generally exothermic and cooling may be desired. However, heating to a moderate temperature of about 50 to 150° C. may be done to hasten the reaction.

The tertiary amine functional polymer (or the reaction product of the primary and/or secondary amine and the epoxide functional polymer) is rendered cationic and water dispersible by at least partial neutralization with an acid. Suitable acids include organic and inorganic acids such as formic acid, acetic acid, lactic acid, phosphoric acid, dimethylolpropionic acid, and sulfamic acid. Lactic acid is used most often. The extent of neutralization varies with the particular reaction product involved. However, sufficient acid should be used to disperse the electrodepositable composition in water. Typically, the amount of acid used provides at least 20 percent of all of the total neutralization. Excess acid may also be used beyond the amount required for 100 percent total neutralization.

In the reaction of a tertiary amine with an epoxide functional polymer, the tertiary amine can be pre-reacted with the neutralizing acid to form the amine salt and then the amine salt reacted with the polymer to form a quaternary salt group-containing resin. The reaction is conducted by mixing the amine salt with the polymer in water. Typically the water is present in an amount ranging from about 1.75 to about 20 percent by weight based on total reaction mixture solids.

In forming the quaternary ammonium salt group-containing resin, the reaction temperature can be varied from the lowest temperature at which the reaction will proceed, generally at or slightly above room temperature, to a maximum temperature of about 100° C. (at atmospheric pressure). At higher pressures, higher reaction temperatures may be used. Usually the reaction temperature is in the range of about 60 to 100° C. Solvents such as a sterically hindered ester, ether, or sterically hindered ketone may be used, but their use is not necessary.

In addition to the primary, secondary, and tertiary amines disclosed above, a portion of the amine that is reacted with the polymer can be a ketimine of a polyamine, such as is described in U.S. Pat. No. 4,104,147, column 6, line 23 to column 7, line 23. The ketimine groups decompose upon dispersing the amine-epoxy reaction product in water.

In addition to resins containing amine salts and quaternary ammonium salt groups, cationic resins containing ternary sulfonium groups may be used in forming the cationic salt group-containing resin (1). Examples of these resins and their method of preparation are described in U.S. Pat. No. 3,793,278 to DeBona and U.S. Pat. No. 3,959,106 to Bosso et al., incorporated herein by reference.

The extent of cationic salt group formation should be such that when the resin is mixed with an aqueous medium and the other ingredients, a stable dispersion of the electrodepositable composition will form. By “stable dispersion” is meant one that does not settle or is easily redispersible if some settling occurs. Moreover, the dispersion should be of sufficient cationic character that the dispersed particles will migrate toward and electrodeposit on a cathode when an electrical potential is set up between an anode and a cathode immersed in the aqueous dispersion.

Generally, the cationic resin (1) is ungelled and contains from about 0.1 to 3.0, often from about 0.1 to 0.7 millequivalents of cationic salt group per gram of resin solids. By “ungelled” is meant that the resin is substantially free from crosslinking, and prior to cationic salt group formation, the resin has a measurable intrinsic viscosity when dissolved in a suitable solvent. In contrast, a gelled resin, having an essentially infinite molecular weight, would have an intrinsic viscosity too high to measure.

The active hydrogens associated with the cationic resin include any active hydrogens which are reactive with isocyanates within the temperature range of about 93 to 204° C., usually about 121 to 177° C. Typically, the active hydrogens comprise hydroxyl and primary and secondary amino, including mixed groups such as hydroxyl and primary amino. Typically, the resin will have an active hydrogen content of about 1.7 to 10 millequivalents, more often about 2.0 to 5 millequivalents of active hydrogen per gram of resin solids.

The cationic salt group-containing resin (1) is typically present in the electrodepositable composition of the present invention in an amount of 50 to 90 percent, often 55 to 75 percent by weight, based on the total weight of resin solids in the electrodepositable film-forming composition.

The second component (2) in the resinous phase of the film-forming composition of the present invention comprises a cationic acrylic resin (polymer) containing urethane functional groups.

Suitable acrylic polymers include copolymers of one or more alkyl esters of acrylic acid or methacrylic acid, optionally together with one or more other polymerizable ethylenically unsaturated monomers. Useful alkyl esters of acrylic acid or methacrylic acid include aliphatic alkyl esters containing from 1 to 30, and preferably 4 to 18 carbon atoms in the alkyl group. Non-limiting examples include methyl methacrylate, ethyl methacrylate, butyl methacrylate, ethyl acrylate, butyl acrylate, and 2-ethyl hexyl acrylate. Suitable other copolymerizable ethylenically unsaturated monomers include vinyl aromatic compounds such as styrene and vinyl toluene; nitriles such as acrylonitrile and methacrylonitrile; vinyl and vinylidene halides such as vinyl chloride and vinylidene fluoride and vinyl esters such as vinyl acetate.

The acrylic copolymer can include hydroxyl functional groups, which are often incorporated into the polymer by including one or more hydroxyl functional monomers in the reactants used to produce the copolymer. Useful hydroxyl functional monomers include hydroxyalkyl acrylates and methacrylates, typically having 2 to 4 carbon atoms in the hydroxyalkyl group, such as hydroxyethyl acrylate, hydroxypropyl acrylate, 4-hydroxybutyl acrylate, hydroxy functional adducts of caprolactone and hydroxyalkyl acrylates, and corresponding methacrylates, as well as the beta-hydroxy ester functional monomers described below. The acrylic polymer can also be prepared with N-(alkoxymethyl)acrylamides and N-(alkoxymethyl)methacrylamides.

Beta-hydroxy ester functional monomers can be prepared from ethylenically unsaturated, epoxy functional monomers and carboxylic acids having from about 13 to about 20 carbon atoms, or from ethylenically unsaturated acid functional monomers and epoxy compounds containing at least 5 carbon atoms which are not polymerizable with the ethylenically unsaturated acid functional monomer.

Useful ethylenically unsaturated, epoxy functional monomers used to prepare the beta-hydroxy ester functional monomers include, but are not limited to, glycidyl acrylate, glycidyl methacrylate, allyl glycidyl ether, methallyl glycidyl ether, 1:1 (molar) adducts of ethylenically unsaturated monoisocyanates with hydroxy functional monoepoxides such as glycidol, and glycidyl esters of polymerizable polycarboxylic acids such as maleic acid. Glycidyl acrylate and glycidyl methacrylate are preferred. Examples of carboxylic acids include, but are not limited to, saturated monocarboxylic acids such as isostearic acid and aromatic unsaturated carboxylic acids.

Useful ethylenically unsaturated acid functional monomers used to prepare the beta-hydroxy ester functional monomers include monocarboxylic acids such as acrylic acid, methacrylic acid, crotonic acid; dicarboxylic acids such as itaconic acid, maleic acid and fumaric acid; and monoesters of dicarboxylic acids such as monobutyl maleate and monobutyl itaconate. The ethylenically unsaturated acid functional monomer and epoxy compound are typically reacted in a 1:1 equivalent ratio. The epoxy compound does not contain ethylenic unsaturation that would participate in free radical-initiated polymerization with the unsaturated acid functional monomer. Useful epoxy compounds include 1,2-pentene oxide, styrene oxide and glycidyl esters or ethers, preferably containing from 8 to 30 carbon atoms, such as butyl glycidyl ether, octyl glycidyl ether, phenyl glycidyl ether and para-(tertiary butyl) phenyl glycidyl ether. Preferred glycidyl esters include those of the structure:

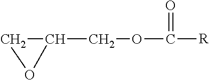

where R is a hydrocarbon radical containing from about 4 to about 26 carbon atoms. Preferably, R is a branched hydrocarbon group having from about 8 to about 10 carbon atoms, such as neopentanoate, neoheptanoate or neodecanoate. Suitable glycidyl esters of carboxylic acids include VERSATIC ACID 911 and CARDURA E, each of which are commercially available from Shell Chemical Co.

Amide functionality may be introduced to the acrylic polymer by using suitably functional monomers in the preparation of the polymer, or by converting other functional groups to amido-groups using techniques known to those skilled in the art. Likewise, other functional groups may be incorporated as desired using suitably functional monomers if available or conversion reactions as necessary.

In a particular embodiment of the present invention, the acrylic resin is a polymerization product of a monomer mixture comprising 50 to 70 percent by weight styrene, 10 to 15 percent by weight glycidyl methacrylate, 5 to 15 percent by weight hydroxyethyl acrylate, 5 to 15 percent by weight hydroxyethyl methacrylate, and methyl styrene dimer.

Acrylic polymers can be prepared via aqueous emulsion polymerization techniques and used directly in the preparation of the aqueous coating compositions, or can be prepared via organic solution polymerization techniques with groups capable of salt formation such as acid or amine groups. Upon neutralization of these groups with a base or acid the polymers can be dispersed into aqueous medium. Generally any method of producing such polymers that is known to those skilled in the art utilizing art recognized amounts of monomers can be used.

In certain embodiments of the present invention, the cationic acrylic resin (2) comprises a reaction product of a reaction mixture comprising: (i) an acrylic resin prepared as described above, having functional groups such as epoxide that are reactive with amines and (ii) a urethane functional amine compound. In this scenario, the urethane functional amine compound is post-reacted with the acrylic polymer after the acrylic polymer is formed.

In alternative embodiments, the monomer mixture used to prepare the acrylic polymer contains an ethylenically unsaturated reaction product prepared from the urethane functional amine compound. The ethylenically unsaturated reaction product is typically prepared from a reaction mixture comprising: (i) an ethylenically unsaturated monomer having functional groups such as epoxide that are reactive with amines and (ii) a urethane functional amine compound. This ethylenically unsaturated reaction product reacts with the other ethylenically unsaturated monomers in the monomer mixture to form the acrylic polymer.

Examples of ethylenically unsaturated monomers having functional groups that are reactive with amines include, inter alia, glycidyl methacrylate.

Whether it is post-reacted with the acrylic polymer after its formation, or used to prepare a monomer for reaction with other ethylenically unsaturated monomers in the monomer mixture, the urethane functional amine compound comprises a reaction product of a reaction mixture comprising (a) a polyamine having at least one primary amino group and at least one secondary amino group; and (b) a cyclic carbonate.

The polyamine (a) is typically aliphatic and may be selected from diethylene triamine, hexamethylene triamine, and the like. Primary amine groups on the polyamine react preferentially with carbonates, leaving secondary amine groups available to react with epoxides or other functional groups on the acrylic polymer or ethylenically unsaturated monomer.

Suitable cyclic carbonates (b) used to prepare the urethane functional amine compound include ethylene carbonate and propylene carbonate.

The acrylic resin (2) used in the composition of the present invention contains cationic salt groups. The cationic salt groups may be incorporated into the resin by reacting epoxide groups in the resin with a cationic salt group former, in a manner similar to those described above for the polyepoxide. Moreover, reaction of epoxide groups on the acrylic resin with cationic salt group formers may be done simultaneously with reaction of epoxide groups on the acrylic resin with the urethane functional amine compound.

The cationic acrylic resin (2) is typically present in the electrodepositable composition of the present invention in an amount of 25 to 50 percent, often 30 to 40 percent by weight, based on the total weight of resin solids in the electrodepositable film-forming composition.

The third component (3) in the resinous phase of the film-forming composition of the present invention comprises an at least partially blocked polyisocyanate curing agent.

Suitable isocyanates for use in the present invention include monomeric and/or polymeric isocyanates. The isocyanates can be selected from monomers, prepolymers, oligomers, or blends thereof. The isocyanate can be C₂-C₂₀ linear, branched, cyclic, aromatic, aliphatic, or combinations thereof.

Suitable isocyanates for use in the present invention may include isophorone diisocyanate (IPDI), which is 3,3,5-trimethyl-5-isocyanato-methyl-cyclohexyl isocyanate; hydrogenated materials such as cyclohexylene diisocyanate, 4,4′-methylenedicyclohexyl diisocyanate (H₁₂MDI); mixed aralkyl diisocyanates such as tetramethylxylyl diisocyanates, OCN—C(CH₃)₂—C₆H₄C(CH₃)₂—NCO; polymethylene isocyanates such as 1,4-tetramethylene diisocyanate, 1,5-pentamethylene diisocyanate, 1,6-hexamethylene diisocyanate (HMDI), 1,7-heptamethylene diisocyanate, 2,2,4-and 2,4,4-trimethylhexamethylene diisocyanate, 1,10-decamethylene diisocyanate and 2-methyl-1,5-pentamethylene diisocyanate; and mixtures thereof.

In certain embodiments of the present invention, the isocyanate can include oligomeric isocyanate such as but not limited to dimers such as the uretdione of 1,6-hexamethylene diisocyanate, trimers such as the biuret and isocyanurate of 1,6-hexanediisocyanate and the isocyanurate of isophorone diisocyanate, allophonates and polymeric oligomers. Modified isocyanates can also be used, including carbodiimides and uretone-imines, and mixtures thereof. Suitable materials include those available under the designation DESMODUR from Bayer Corporation of Pittsburgh, Pa., such as DESMODUR N 3200, DESMODUR N 3300, DESMODUR N 3400, DESMODUR XP 2410 and DESMODUR XP 2580.

In some embodiments, the isocyanate component comprises an isocyanate functional prepolymer formed from a reaction mixture comprising an isocyanate and another material. Any isocyanate known in the art, such as any of those described above, can be used in the formation of the prepolymer. As used herein, an “isocyanate functional prepolymer” refers to the reaction product of isocyanate with polyamine and/or other isocyanate reactive group such as polyol; the isocyanate functional prepolymer has at least one isocyanate functional group (NCO).

In some embodiments, the polyol used in the formation of the prepolymer is, for example, polytetrahydrofuran materials such as those sold under the trade name TERATHANE (e.g., TERATHANE 250, TERATHANE 650, and TERATHANE 1000 available from Invista Corporation).

In certain embodiments, the isocyanate component comprises an isocyanate (non-prepolymer isocyanate) and an isocyanate functional prepolymer. The non-prepolymer isocyanate can be the same or different from the isocyanate used to form the isocyanate functional prepolymer. If combinations of isocyanates are used, the isocyanates should be substantially compatible; for example, the isocyanate functional prepolymers can be substantially compatible with the non-prepolymer isocyanate. As used herein, “substantially compatible” means the ability of a material to form a blend with other materials that is and will remain substantially homogeneous over time. The reaction of an isocyanate with an organic material, such as in the formation of an isocyanate functional prepolymer, helps to compatibilize the isocyanate.

In particular embodiments of the present invention, the polyisocyanate comprises a polyether polyol, polyester polyol, and/or a polyether polyamine prepolymer chain-extended with a polyisocyanate selected from isophorone diisocyanate, cyclohexylene diisocyanate, 4,4′-methylenedicyclohexyl diisocyanate; tetramethylxylyl diisocyanates, 1,4-tetramethylene diisocyanate, 1,5-pentamethylene diisocyanate, 1,6-hexamethylene diisocyanate, 1,7-heptamethylene diisocyanate, 2,2,4-and 2,4,4-trimethylhexamethylene diisocyanate, 1,10-decamethylene diisocyanate, 2-methyl-1,5-pentamethylene diisocyanate, phenylene diisocyanate, toluene diisocyanate, xylene diisocyanate, 1,5-naphthalene diisocyanate, chlorophenylene 2,4-diisocyanate, bitoluene diisocyanate, dianisidine diisocyanate, tolidine diisocyanate, methylenediphenyl diisocyanate, 3,3′-dimethyl-4,4′-diphenylmethane diisocyanate, polymeric methylenediphenyl diisocyanate, and mixtures thereof.

By “blocked” is meant that the isocyanate groups have been reacted with a compound such that the resultant blocked isocyanate group is stable to active hydrogens at ambient temperature but reactive with active hydrogens in the film forming polymer at elevated temperatures usually between 90° C. and 200° C. In certain embodiments of the present invention, the polyisocyanate curing agent is a fully blocked polyisocyanate with substantially no free isocyanate groups. Any suitable aliphatic, cycloaliphatic, or aromatic alkyl monoalcohol or phenolic compound known to those skilled in the art can be used as a capping agent for the polyisocyanate. Examples of suitable blocking agents include those materials which would unblock at elevated temperatures such as lower aliphatic alcohols including methanol, ethanol, and n-butanol; cycloaliphatic alcohols such as cyclohexanol; aromatic-alkyl alcohols such as phenyl carbinol and methylphenyl carbinol; and phenolic compounds such as phenol itself and substituted phenols wherein the substituents do not affect coating operations, such as cresol and nitrophenol. Glycol ethers may also be used as capping agents. Suitable glycol ethers include ethylene glycol butyl ether, diethylene glycol butyl ether, ethylene glycol methyl ether and propylene glycol methyl ether. Other suitable capping agents include oximes such as methyl ethyl ketoxime, acetone oxime and cyclohexanone oxime, lactams such as epsilon-caprolactam, pyrazoles such as dimethylpyrazole, and amines such as dibutyl amine.

The at least partially blocked polyisocyanate curing agent (3) can be present in the electrodepositable film-forming composition of the present invention in an amount ranging from 10 to 50 percent, often from 25 to 45 percent by weight, based on the total weight of resin solids in the film-forming composition.

The compositions used in the present invention can also include a colorant. As used herein, the term “colorant” means any substance that imparts color but not necessarily opacity to the composition. The colorant should be selected to yield the desired visual effect of the composition. For example, the colorant does not typically affect the clarity or transparency of the composition. The colorant can be added to the coating in any suitable form, such as discrete particles, dispersions, solutions and/or flakes. A single colorant or a mixture of two or more colorants can be used in the coatings of the present invention. Optionally, the colorant may impart some opacity to create a translucent coating.

Example colorants include pigments, dyes and tints, such as those listed in the Dry Color Manufacturers Association (DCMA), as well as special effect compositions. A colorant can be organic or inorganic. Colorants can be incorporated into the coatings by grinding or simple mixing. Colorants can be incorporated by grinding into the coating by use of a grind vehicle, such as an acrylic or amine grind vehicle, the use of which will be familiar to one skilled in the art.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to COLORMATCH AD series commercially available from Plasticolors, CHARISMA COLORANTS and MAXITONER INDUSTRIAL COLORANTS commercially available from Accurate Dispersions division of Eastman Chemical, Inc.

Particularly suitable colorants are transparent pigments, transparent dyes or tints that are reflective of infrared light.

As noted above, the colorant can be in the form of a dispersion including, for example, a nanoparticle dispersion. Nanoparticle dispersions can include one or more highly dispersed nanoparticle colorants and/or colorant particles that produce a desired visible color and/or visual effect. Nanoparticle dispersions can include colorants such as dyes having a particle size of less than 150 nm, such as less than 70 nm, or less than 30 nm. Nanoparticles can be produced by milling stock organic or inorganic pigments with grinding media having a particle size of less than 0.5 mm. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle.

In certain embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition is irradiated, the molecular structure is changed and the altered structure exhibits a new color that is different from the original color of the composition. When the exposure to radiation is removed, the photochromic and/or photosensitive composition can return to a state of rest, in which the original color of the composition returns. For example, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In general, the colorant can be present in the coating composition in any amount sufficient to impart the desired property, visual and/or color effect. The colorant may comprise from 1 to 65 weight percent of the present compositions, such as from 3 to 40 weight percent or 5 to 35 weight percent, with weight percent based on the total weight of the compositions.

The curable, electrodepositable coating composition of the present invention may additionally include optional ingredients commonly used in such compositions. For example, the composition may further comprise a hindered amine light stabilizer for UV degradation resistance. Such hindered amine light stabilizers include those disclosed in U.S. Pat. No. 5,260,135. When they are used they are present in the electrodepositable composition in an amount of 0.1 to 2 percent by weight, based on the total weight of resin solids in the electrodepositable composition. Other optional additives such as surfactants, wetting agents or catalysts can be included in the composition.

Catalysts include those effective for reactions of isocyanates with active hydrogens. The catalysts, which are often solids, are typically dispersed in a conventional pigment grinding vehicle such as those disclosed in U.S. Pat. No. 4,007,154, by a grinding or milling process. As such, they may be added to the electrodepositable composition as a separate component or they may be part of the additive composition (3) that is incorporated into the electrodepositable composition. The catalysts are typically used in amounts of about 0.05 to 2 percent by weight metal based on weight of total solids. Suitable catalysts include tin compounds such as triphenyl tin hydroxide, butyl stannoic acid, dioctyltin oxide, dibutyltin dilaurate, dibutyltin diacetate, and dibutyltin oxide.

The electrodepositable compositions of the present invention are typically prepared as electrodeposition baths, diluted with water. The composition used as an electrodeposition bath in the process of the present invention has a resin solids content usually within the range of about 5 to 30 percent by weight, often 10 to 30 percent by weight or 5 to 25 percent by weight based on total weight of the electrodeposition bath.

Besides water, the aqueous medium of the electrodeposition bath may contain a coalescing solvent. Useful coalescing solvents include hydrocarbons, alcohols, esters, ethers and ketones. The most commonly used coalescing solvents include alcohols, polyols and ketones. Specific coalescing solvents include isopropanol, butanol, 2-ethylhexanol, isophorone, 2-methoxypentanone, ethylene and propylene glycol and the monoethyl, monobutyl and monohexyl ethers of ethylene glycol. The amount of coalescing solvent is generally between about 0.01 and 25 percent and when used, often from about 0.05 to about 5 percent by weight based on total weight of the aqueous medium.

The curable, electrodepositable coating composition of the present invention may be prepared using the following process:

(1) combining the resin components as described above containing one or more of the active hydrogen-containing, cationic salt group-containing resins described earlier with an at least partially capped polyisocyanate curing agent to form a reactive mixture;

(2) adding a catalyst composition to the reactive mixture; and

(3) diluting the reactive mixture with water to a solids content of 10 to 30 percent by weight, based on the total weight of the reactive mixture. Note that the order of process steps may be altered without departing from the spirit of the invention.

In certain embodiments of the present invention, after diluting the reactive mixture with water to a solids content of up to 30 percent by weight, a portion (usually twenty percent by weight) of the reactive mixture may be removed by ultrafiltration and replaced with deionized water.

The present invention is also drawn to a coated metal substrate comprising:
A) a metal substrate having at least one coatable surface, and
B) a cured coating layer deposited on at least one surface of the substrate. The cured coating layer is deposited from the electrodepositable film-forming composition described above. The coating layer has a coating/air interface and a coating/substrate interface, and the coating composition forms striated resin layers; i.e., the cationic acrylic resin is concentrated at the coating/air interface while the cationic resin derived from a polyepoxide is concentrated at the coating/substrate interface. In other words, there is more acrylic resin than polyepoxide resin at the coating/air interface of the coating layer and more polyepoxide resin than acrylic resin at the coating/substrate interface of the coating layer. In addition, the concentration of acrylic resin is greater in the coating/air surface region (e.g., the top 10 percent of the film thickness) than in the bulk of the coating layer. Likewise, the concentration of polyepoxide resin is greater in the coating/substrate surface region (e.g., the bottom 10 percent of the film thickness) than in the bulk of the coating layer. It is believed that the striation of these resin layers, in combination with the chemistry of each, contributes to improved durability of the coated substrate, in particular, better UV light resistance and less chalking of the coating.

Substrates to which compositions of the present invention may be applied are electroconductive and include rigid metal substrates such as ferrous metals, aluminum, aluminum alloys, copper, and other metal and alloy substrates. The ferrous metal substrates used in the practice of the present invention may include iron, steel, and alloys thereof. Non-limiting examples of useful steel materials include cold rolled steel, galvanized (zinc coated) steel, electrogalvanized steel, stainless steel, pickled steel, zinc-iron alloy such as GALVANNEAL, and combinations thereof. Combinations or composites of ferrous and non-ferrous metals can also be used.

The shape of the metal substrate can be in the form of a sheet, plate, bar, rod or any shape desired, but it is usually in the form of an automobile part, such as a body, door, fender, hood or bumper. The thickness of the substrate can vary as desired.

The present invention is also drawn to a method for forming a composite coating on an electroconductive substrate, comprising the following steps:

(a) electrophoretically depositing on the substrate the curable, electrodepositable coating composition described above to form an electrodeposited coating over at least a portion of the substrate;

(b) heating the coated substrate to a temperature and for a time sufficient to cure the electrodeposited coating on the substrate;

(c) applying directly to the cured electrodeposited coating a first coating composition to form a top coat over at least a portion of the cured electrodeposited coating;

(d) applying a second coating composition to at least a portion of the first coating formed in step (c) prior to substantially curing the first coating, to form a secondary top coat thereon;

(e) heating the coated substrate formed in step (d) to a temperature and for a time sufficient to cure all the top coats.

The application of multiple coatings wet-on-wet followed by simultaneous curing defines this as a compact process. The need for a separate primer layer or primer-surfacer is advantageously eliminated.

Before depositing any coating compositions upon the surface of the substrate, it is common practice, though not necessary, to remove foreign matter from the surface by thoroughly cleaning and degreasing the surface. Such cleaning typically takes place after forming the substrate (stamping, welding, etc.) into an end-use shape. The surface of the substrate can be cleaned by physical or chemical means, or both, such as mechanically abrading the surface or cleaning/degreasing with commercially available alkaline or acidic cleaning agents which are well known to those skilled in the art, such as sodium metasilicate and sodium hydroxide. A non-limiting example of a cleaning agent is CHEMKLEEN 163, an alkaline-based cleaner commercially available from PPG Industries, Inc.

Following the cleaning step, the substrate may be rinsed with deionized water or an aqueous solution of rinsing agents in order to remove any residue. The substrate can be air dried, for example, by using an air knife, by flashing off the water by brief exposure of the substrate to a high temperature or by passing the substrate between squeegee rolls.

In the process of electrodeposition, the metal substrate being coated, serving as an electrode, and an electrically conductive counter electrode are placed in contact with an ionic, electrodepositable composition. Upon passage of an electric current between the electrode and counter electrode while they are in contact with the electrodepositable composition, an adherent film of the electrodepositable composition will deposit in a substantially continuous manner on the metal substrate. In the process of the present invention the metal substrate being coated serves as a cathode, and the electrodepositable composition is cationic.

Electrodeposition is usually carried out at a constant voltage in the range of from about 1 volt to several thousand volts, typically between 50 and 500 volts. Current density is usually between about 1.0 ampere and 15 amperes per square foot (10.8 to 161.5 amperes per square meter) and tends to decrease quickly during the electrodeposition process, indicating formation of a continuous self-insulating film.

After electrodeposition, the coated substrate is heated to cure the deposited composition. The heating or curing operation is usually carried out at a temperature in the range of from 250 to 450° F. (121.1 to 232.2° C.), often 300 to 450° F. (148.9 to 232.2° C.), more often 300 to 400° F. (148.9 to 204.4° C.) for a period of time sufficient to effect cure of the composition, typically ranging from 10 to 60 minutes. The thickness of the resultant film is usually from about 10 to 50 microns. By “cure” is meant a chemical reaction between the active hydrogen-containing, cationic salt group-containing resins and the polyisocyanate curing agent resulting in a substantially crosslinked film.

In step (c) of the process of the present invention, a first coating composition is applied directly to the cured electrodeposited coating to form a top coat over at least a portion of the electrodeposited coating. The first coating composition typically comprises a pigmented top coat. The first coating composition may be any top coat composition known in the art of surface coatings; it is typically a curable film-forming composition comprising a polymeric binder with functional groups and a curing agent having functional groups reactive with those on the polymeric binder. It may be waterborne or solventborne.

The first coating composition, and all subsequent coating layers, may be applied to the substrate by one or more of a number of methods including spraying, rolling, curtain coating, dipping/immersion, brushing, or flow coating, but they are most often applied by spraying. The usual spray techniques and equipment for air spraying and electrostatic spraying and either manual or automatic methods can be used. The first coating layer typically has a dry (film thickness of 15 to 30 microns.

After forming a film of the first coating layer on the substrate, the first coating layer can be given a drying step (flash) in which solvent is driven out of the coating film by heating or an air drying period at room temperature before application of the second coating composition. Suitable drying conditions may depend, for example, on the ambient temperature and humidity. Alternatively, the second coating composition may be applied immediately to the first without drying the first coating. In any event, the second coating composition is applied to at least a portion of the uncured first coating formed in step (c) prior to substantially curing the first coating, forming a substantially uncured secondary coating thereon. Such a coating process is often referred to as “wet-on-wet”.

The second coating composition may be applied to the first coating layer using any of the methods described above.

The second coating composition may be any of those known in the art of surface coatings; it is typically a curable film-forming composition comprising a polymeric binder with functional groups and a curing agent having functional groups reactive with those on the polymeric binder. It may be waterborne or solventborne. It may be the same as or different from the first coating composition. If it has the same resin composition as the first coating composition, it may be the same color or a different color. It may alternatively be transparent; i.e., a clearcoat. Like the film-forming composition used as the first coating layer, the second coating composition can include a variety of optional ingredients and/or additives such as curing catalysts, pigments or other colorants, reinforcements, thixotropes, accelerators, surfactants, plasticizers, extenders, stabilizers, corrosion inhibitors, diluents, hindered amine light stabilizers, UV light absorbers, and antioxidants.

After application of the second coating composition to the first, forming a composite coating on the substrate, the coated substrate may be held at a temperature and for a time sufficient to substantially cure all the top coat layers. Such cure protocols typically include a temperature range of 70 to 180° C. for a time of 10 to 120 minutes.

The second coating layer typically has a dry film thickness of 10 to 25 microns.

Coated substrates prepared in accordance with the method of the present invention demonstrate improved durability, UV resistance, and/or chip resistance (including GALVANNEAL chip and splitting resistance) after curing compared to coated substrates prepared using conventional processes or other compact processes. This is in part due to the composition and resin striation of the electrodeposited coating layer. The total thickness of a composite coating prepared by the process of the present invention is typically 25 to 105 microns, depending on the total number of applied layers.

The following examples are intended to illustrate various embodiments of the invention, and should not be construed as limiting the invention in any way.

### Example I

Example I illustrates the preparation of a stratifying acrylic resin.

| | | Parts by |
|---|---|---|
| Material # | Description | Weight |
| 1 | Methyl isobutyl ketone | 102.0 |
| 2 | Glycidyl methacrylate | 100.0 |
| 3 | 2-ethylhexylacrylate | 60.0 |
| 4 | Styrene | 645.0 |
| 5 | hydroxyethyl methacrylate | 195.0 |
| 6 | α-methyl styrene dimer | 64.0 |
| 7 | 2,2′-Azobis(2-methylbutyronitrile) | 48.6 |
| 8 | Methyl isobutyl ketone | 162.0 |
| 9 | t-amyl peroxyoctoate | 16.5 |
| 10 | Methyl isobutyl ketone | 33.0 |
| 11 | Diethanolamine | 34.3 |
| 12 | bishexamethylenetriamine (BHMT) | 200.6 |
| | propylene carbonate¹ | |
| 13 | Cyanox 1010² | 15.4 |
| 14 | Cyasorb 3346³ | 10.9 |
| 15 | 2-butoxy ethanol | 66.1 |
| 16 | bis[2-(2-butoxyethoxy)ethoxy]methane | 66.1 |
| 17 | 2-butoxy ethanol | 91.0 |

¹BHMT - propylene carbonate was synthesized by adding 70.3 parts propylene carbonate dropwise to 90.2 parts BHMT while keeping the temperature below 70° C. The reaction was then held for one hour at 70° C. and 40.1 parts methyl isobutyl ketone were added to the mixture
²CYANOX 1010 is available from Cytec Industries
³CYASORB 3346 is available from Cytec Industries

Material 1 was charged to a 4 neck round bottom flask, fit with a stirrer, temperature probe, and nitrogen inlet. A nitrogen blanket was applied to the flask while the materials were being charged to the flask. Ten percent by weight of materials 2 through 8, which had been premixed, were then added to the flask and the contents were heated to 110° C. while maintaining a nitrogen blanket. At 110° C., the remainder of materials 2 through 8 were added over two hours. Upon completion of the addition, the reaction was held for 30 minutes at 110-115° C. The epoxy equivalent weight was measured on the solution and found to be 1,919 (theory=2,025). Materials 9 and 10 were then combined and added to the flask over 15 minutes. Upon completion of the addition, the reaction was held for 30 minutes between 110-115° C. Material 11 was then added and held for 30 minutes at 110° C., followed by the addition of material 12. Upon completion of material 12, the reaction was held for 2 hours at 110° C. After 2 hours, materials 13 through 16 were added and the resin solution was mixed for 30 minutes at 110° C. Material 17 was then added and the resin solution poured out.

### Example II

Example II illustrates the dispersion of the acrylic resin prepared in Example I and subsequent evaporation of solvent methylisobutylketone (MIBK).

A portion of the solventborne resin of Example I was heated at 120° F. to reduce its viscosity. 212.9 grams of the resin was combined with 15 grams of isopropyl alcohol and mixed until uniform with a stainless steel propeller type mixing blade. 56.2 grams of a 10% solution of sulfamic acid was added and mixed until uniform. 626 grams of deionized water was added slowly to form an aqueous dispersion of the acrylic resin. The aqueous dispersion was stirred overnight in an open 32 ounce plastic cup using a magnetic stirring bar to evaporate a majority of the methylisobutylketone solvent. After adding an amount of deionized water equal to the weight lost to evaporation, the evaporated dispersion had calculated % solids of 17.2%.

### Example III

Example III illustrates the preparation of an epoxy resin:

Crosslinker

| Material | gm |
|---|---|
| Isocyanate¹ | 1876.00 |
| Dibutyltin dilaurate | 0.35 |
| Methyl isobutyl ketone (mibk) | 21.73 |
| Diethyleneglycol monobutyl ether | 454.24 |
| Ethyleneglycol monobutyl ether | 1323.62 |
| Methylisobutyl ketone (mibk) | 296.01 |

¹RUBINATE M, available from Huntsman Corporation

Procedure: All weights are in grams. Items 1, 2 and 3 are charged to a 4 neck round bottom flask, fit with a stirrer, temperature measuring probe and N₂ blanket. Charge 4 is added slowly allowing the temperature to increase to 60° C. The mixture is then held at 60° C. for 30 minutes. Charge 5 is then added over about 2 hours allowing the temperature to increase to a maximum of 110° C. Charge 6 is then added and the mixture is held at 110° C. until the IR spectrum indicates no residual isocyanate.

| # | Material | gm |
|---|---|---|
| 1 | Epon 828¹ | 614.68 |
| 2 | Bisphenol A | 265.42 |
| 3 | MACOL 98 A MOD 1² | 125.0 |
| 4 | Methylisobutyl ketone (mibk) | 31.09 |
| 5 | Ethyltriphenyl phosphonium iodide | 0.60 |
| 6 | MACOL 98 A MOD 1² | 125.00 |
| 7 | Methylisobutyl ketone (mibk) | 50.10 |
| 8 | crosslinker 1 (see above) | 894.95 |
| 9 | Ketimine³ | 57.01 |
| 10 | N-methyl ethanolamine | 48.68 |
| 11 | sulfamic acid | 40.52 |
| 12 | H₂O | 1196.9 |
| 13 | Gum rosin solution⁴ | 17.92 |
| 14 | H₂O | 1623.3 |
| 15 | H₂O | 1100.0 |

¹Epoxy resin available from Hexion Specialty Chemicals.
²Bisphenol ethylene oxide adduct available from BASF Corporation.
³MIBK diketimine of diethylene triamine at 72.7% in MIBK.
⁴30% by weight solution of gum rosin in diethylene glycol mono butyl ether formal.

Procedure: All weights are in grams. Items 1, 2, 3, 4 and 5 are charged to a 4 neck round bottom flask, fit with a stirrer, temperature measuring probe, N₂ blanket and heated to 130° C. The mixture exotherms to about 150° C. The temperature is allowed to drop to 145° C. and held at this temperature for 2 hours. Charges 6 and 7 were then added. Charges 8, 9 and 10 were added and the mixture was held at 122° C. for two hours. 1991 g of the reaction mixture is poured into a solution of items 11 and 12 with good stirring. Charge 13 was then added and the resulting dispersion is mixed for thirty minutes and then charge 14 is added with stirring over about 30 minutes and mixed well. Charge 15 is added and mixed well. About 1100 g of water and solvent are distilled off under vacuum at 60-65° C. The resulting aqueous dispersion had a solids content of 39.37%. The above composition was vacuum distilled to remove organic solvent and adjusted with deionized water to a solids content of 42.5%.

### Example IV

Example IV illustrates the preparation of an amine diol resin.

Material

| | | |
|---|---|---|
| 1 | MAZEEN 355 70¹ | 1423.49 |
| 2 | acetic acid | 15.12 |
| 3 | Dibutyltindilaurate | 1.52 |
| 4 | Toluene diisocyanate 80/20 | 200.50 |
| 5 | acetic acid | 49.32 |
| 6 | Deionized water | 1623.68 |
| 7 | Deionized water | 766.89 |

¹Amine functional diol of amine equivalent weight 1131 available from BASF Corporation

Materials 1 and 2 were charged to a 4 neck round bottom flask, fit with a stirrer, temperature measuring probe and N2 blanket and mixed for 10 minutes. Material 3 was added and then material 4 was charged over about 1 hour allowing the reaction mixture to exotherm to a maximum temperature of 100° C. The mixture was then held at 100° C. until the infrared spectrum indicates the absence of isocyanate (approximately 1 hour). 1395 g of the reaction mixture was then poured into a mixture of materials 5 and 6 and mixed for 1 hour. Material 7 was then added over about 1 hour and mixed for about 1 hour. The resulting aqueous solution had a solids content of about 36%.

### Example V

Example V illustrates the preparation of an electrocoat bath formulation using stratifying acrylic and conventional cationic epoxy electrocoat resin.

710.0 grams of the epoxy resin dispersion in Example III was added to a one-gallon plastic container and placed under mild agitation using a 3-inch long football-shaped magnetic stirring bar over a magnetic stirring plate and diluted with 710 grams of deionized water. In a separate plastic container 910.2 grams of the acrylic dispersion in Example II was first diluted with 910 grams of deionized water and the diluted mixture poured slowing into the epoxy dispersion.

In a separate container 18.9 grams of PROPASOL B (n-butyl ether of propylene glycol) was added to 39.4 grams of amine diol resin (Example IV) and mixed by hand with a stainless steel spatula until uniform. This mixture of amine diol resin and PROPASOL B was further diluted with 200 grams of deionized water and added to the epoxy-acrylic blend.

1 weight part of 0.1 Normal Silver Nitrate was combined with 9 weight parts of deionized water to yield a solution of 0.106% Silver. 11.8 grams of this dilute Silver solution was added to the epoxy-acrylic resin blend to complete the resin component of the electrocoat bath composition.

160.3 grams of a pigment paste E6364 available from PPG Industries, Inc., was added directly to the resin blend of this example to complete the electrocoat bath formulation.

### Example VI

The procedure in Example V was followed using the same weights of materials except that instead of 18.9 grams of PROPASOL B being added to the amine diol resin, 18.9 grams of BUTYLCARBITOL formal was used instead to prepare an electrocoat bath.

### Example VII

Example VII illustrates the preparation of a conventional epoxy electrocoat.

1919.2 grams of a resin blend (E6363 available from PPG Industries, Inc.) was diluted with 1846 grams of deionized water in a plastic one-gallon container under mild agitation using a 3-inch football-shaped magnetic stirring bar. To this diluted resin blend was added 234.7 grams of the pigment paste E6364, also available from PPG Industries, Inc., to complete the electrocoat bath.

### Example VIII

Example VIII illustrates the electrodeposition of coating compositions onto test panels. Electrogalvanized steel panels, 4×12×0.031 inches, pretreated with CHEMFOS C700/C59*, available from PPG Industries, Inc., were electrocoated in the manner well known in the art by immersing them into a stirring bath and connecting the cathode of a direct current rectifier to the panel and connecting the rectifier's anode to a stainless steel tube acting as a cooling element. The voltage was increased from zero to the setpoint of 220 volts over a period of 30 seconds.

After electrodeposition the panels were removed from the bath and rinsed vigorously with a spray of deionized water followed by baking in either an electric oven (25 minutes at 175° C.) or a gas oven (50 minutes at 195° C.).

The following table summarizes the electrodeposition conditions used:

| | Bath | | coating | film |
|---|---|---|---|---|
| | Temperature | | time, | thickness, |
| | ° F. | Voltage | min. | mils* |
| Example V | 90 | 220 | 2.5 | 0.87 |
| Example VI | 88 | 220 | 2.5 | 0.94 |
| Example VII | 88 | 220 | 2 | 0.88 |

*Electrogalvanized steel pretreated with CHEMFOS C700 and a C59 post rinse are available as part number 26917 from ACT Test Panels LLC of Hillsdale, MI 49242

### Testing of Electrocoated Panels in Accelerated Weathering:

Test panels were prepared as above except that they were baked for 50 minutes in a direct gas fired oven before topcoating. The topcoat comprised a blue water borne basecoat containing hiding pigments followed by a dehydration bake of 5 minutes at 185° F. followed by the application of a two-component acrylic urethane clear coat (TKAPO1100A/TKAPO1100B available from PPG Industries, Inc.) and applied according to the manufacturer's instructions and then by a bake of 30 minutes at 285° F. The basecoat is supplied as Blue Hybrid WBBC, available from PPG Industries, Inc., except that only 30% of its usual pigment paste was used to increase the transmission of light for the purposed of accelerated weathering testing. No other changes were made to the waterborne basecoat coating other than reducing the amount of pigment paste, and such an adjustment is easy for anyone skilled in the art of making water borne topcoats.

Blue Hybrid WBBC topcoat system used in WEATHEROMETER testing:

| | | Clear Coat | |
|---|---|---|---|
| | | film | % |
| Basecoat film | Basecoat | thickness, | Transmission |
| thickness, mils | Pigmentation | mils | at 430 nm |
| 0.77 | 30% | 2.07 | 18.95 |
| 0.76 | 30% | 2.03 | 19.73 |

The test panels were exposed to water, higher temperatures, and light in a Xenon Arc WEATHEROMETER run according to SAEJ2527. Multiple coupons of the electrocoated and topcoated panels were placed in the WEATHEROMETER and removed at successively longer intervals until the coating system failed a crosshatch test.

The crosshatch test uses a scribing tool with teeth set 2 mm apart which cuts the coating system down to metallic substrate. With two such cuts, a “crosshatch” results which is then tested with Scotch 898 tape. Panels from a WEATHEROMETER interval are tested for adhesion after a 24 hour “recovery period” and they are also tested after the 24 hour recovery period followed by exposure to 100% relative humidity at 100° F. for 16 hours. Failure constitutes loss of adhesion between any of the coating layers or between the electrocoat and metallic substrate. Intermediate results for failure are assigned according to the following photographs representing a workmanship standard. WEATHEROMETER hours are recorded as the total amount of time in an operating WEATHEROMETER run according to SAE J2527.

| | | | 300 | | 400 | | 500 | | 800 | | 1000 | | 1300 | | 1500 | |
|---|---|---|---|---|---|---|---|---|---|---|---|---|---|---|---|---|
| Description | Example | Bake | Dry | Humid. | Dry | Humid. | Dry | Humid | Dry | Humid. | Dry | Humid | Dry | Humid | Dry | Humid. |
| Conventional | Example | 50 min. | 10 | 5 | 9 | 1 | 9 | 0 | 1 | 1 | 0 | 0 | | | | |
| Electrocoat | VII | 195° C. | | | | | | | | | | | | | | |
| (Control) | | Gas | | | | | | | | | | | | | | |
| Stratifying | Example | 50 min. | | | | | | | | | 9 | 6 | 8 | 0 | 8 | 0 |
| Acrylic | V | 195° C. | | | | | | | | | | | | | | |
| | | Gas | | | | | | | | | | | | | | |
| Stratifying | Example | 10 min. | | | | | | | | | 10 | 10 | 8 | 8 | 9 | 2 |
| Acrylic | VI | 135° C. | | | | | | | | | | | | | | |
| with | | Elec tric | | | | | | | | | | | | | | |
| BUTYL | | + 50 | | | | | | | | | | | | | | |
| CARBITOL | | min. | | | | | | | | | | | | | | |
| formal | | 195° C. | | | | | | | | | | | | | | |
| | | Gas | | | | | | | | | | | | | | |

Crosshatch ratings “Dry” are with 24 hour recovery period after removing from the WEATHEROMETER
Crosshatch ratings “Humid.” are after 24 hour recovery followed by 16 hours at 100° F. and 100% humidity

The electrodepositable film-forming compositions of the present invention impart improved durability to coating composites which have topcoats with less than perfect blocking of light energy (hiding). It is known that light of wavelengths 420 nanometers and less can be particularly damaging to organic coatings. On the other hand, it can be difficult to provide complete hiding at 420 nanometers and below in some colors. For example, the UV opacity of the common white pigment TiO₂ drops off sharply in the region of 420 to 400 nanometers.

The test summarized in Example VIII is designed to accelerate results which might occur over 1 to 10 years on a production vehicle whose color coatings, while meant to provide UV transmission of essentially zero, might in practice allow transmission of light on the order of several 1/100ths of a percent to 0.1% or greater. Exposure to WEATHEROMETER conditions in SAE2527 for 1500 hours is used as an estimation of one year of horizontal exposure in Florida. Florida itself is considered to be a severe environment for the photodegradation of coatings. By deliberately using a topcoat system having transmission of light as 18% of the incident light, the weathering test of this example is considered to be extremely accelerated.

In the crosshatch ratings, a rating of 9 or 10 is considered passing and a rating of 8 is considered marginal. Ratings of 7 or below are considered failures. Good adhesion after exposure WEATHEROMETER and humidity is the most desirable result. However, there is some value in retaining dry adhesion since the majority of a vehicle's time on the road will likely be spent under dry conditions, with less time spent under wet or humid conditions where small stones may cause mechanical failure known as “stone chip”.

The data in the table (above) show that the performance of the composition of Example V at 1000 hours is equivalent to the performance of the unimproved “control” composition of Example VII.

In example VI, the coating composition was exposed to a short bake below its normal crosslinking temperature to accentuate the melt-reflow which is a normal consequence of baking and curing a conventional electrocoat composition. The baking condition used in example VI is intended to allow improved separation of the coating composition into acrylic rich portions and epoxy rich portions by extending the melt reflow time before crosslinking and cure take place. All coating examples, V, VI, and VII were exposed to the same final bake of 50 minutes using a direct gas fired oven at 195° C.

The data show that the coating composite of Example VI is clearly superior to that of Example VII in that perfect adhesion was maintained after 1000 hours WEATHEROMETER exposure for Example VI, whereas the coating composite of Example VII (control) has already failed and its failure point can be considered to be less than or equal to 300 hours WEATHEROMETER exposure.

Whereas particular embodiments of this invention have been described above for purposes of illustration, it will be evident to those skilled in the art that numerous variations of the details of the present invention may be made without departing from the scope of the invention as defined in the appended claims.

Therefore, we claim:

1. An electrodepositable film-forming composition comprising a resinous phase dispersed in an aqueous medium, said resinous phase comprising:
(1) an ungelled active hydrogen-containing, cationic resin derived from a polyepoxide;
(2) a cationic acrylic resin containing urethane functional groups; and
(3) an at least partially blocked polyisocyanate curing agent, wherein the acrylic resin comprises a reaction product of a reaction mixture comprising: (i) an acrylic resin having functional groups that are reactive with amines and (ii) a urethane functional amine compound, wherein the urethane functional amine compound comprises a reaction product of a reaction mixture comprising (a) a polyamine having at least one primary amino group and at least one secondary amino group; and (b) a cyclic carbonate.

2. The film-forming composition of claim 1, wherein the cationic resin (1) and the cationic acrylic resin (2) contain cationic amine salt groups.

3. The film-forming composition of claim 1, wherein the polyamine having at least one primary amino group and at least one secondary amino group comprises hexamethylene triamine.

4. The film-forming composition of claim 1, wherein the cyclic carbonate comprises propylene carbonate.

5. The film-forming composition of claim 1, wherein the acrylic resin is a polymerization product of a monomer mixture comprising styrene, glycidyl methacrylate, hydroxyethyl acrylate, hydroxyethyl methacrylate, and methyl styrene dimer.

6. The film-forming composition of claim 1, wherein the cationic acrylic resin is present in the film-forming composition in an amount of 30 to 40 percent by weight, based on the total weight of resin solids in the film-forming composition.

7. A coated metal substrate comprising:
A) a metal substrate having at least one coatable surface, and
B) a cured coating layer deposited on at least one surface of the substrate and having a coating/air interface and a coating/substrate interface, wherein the cured coating layer is deposited from the electrodepositable film-forming composition of claim 1; wherein the cationic acrylic resin is concentrated at the coating/air interface and the cationic resin derived from a polyepoxide is concentrated at the coating/substrate interface.

8. An electrodepositable film-forming composition comprising a resinous phase dispersed in an aqueous medium, said resinous phase comprising:
(1) an ungelled active hydrogen-containing, cationic resin derived from a polyepoxide;
(2) a cationic acrylic resin containing urethane functional groups; and
(3) an at least partially blocked polyisocyanate curing agent; wherein the acrylic resin comprises a polymerization product of a monomer mixture, wherein the monomer mixture contains an ethylenically unsaturated reaction product of a reaction mixture comprising: (i) an ethylenically unsaturated monomer having functional groups that are reactive with amines and (ii) a urethane functional amine compound, and wherein the urethane functional amine compound comprises a reaction product of a reaction mixture comprising (a) a polyamine having at least one primary amino group and at least one secondary amino group; and (b) a cyclic carbonate.

9. The film-forming composition of claim 8, wherein the cationic resin (1) and the cationic acrylic resin (2) contain cationic amine salt groups.

10. The film-forming composition of claim 8, wherein the monomer mixture contains an ethylenically unsaturated epoxide functional monomer, and wherein the functional groups that are reactive with amine groups comprise epoxide functional groups.

11. The film-forming composition of claim 8, wherein the polyamine having at least one primary amino group and at least one secondary amino group comprises hexamethylene triamine.

12. The film-forming composition of claim 8, wherein the cyclic carbonate comprises propylene carbonate.

13. The film-forming composition of claim 8, wherein the monomer mixture comprises styrene, glycidyl methacrylate, hydroxyethyl acrylate, hydroxyethyl methacrylate, and methyl styrene dimer.

14. The film-forming composition of claim 8, wherein the cationic acrylic resin is present in the film-forming composition in an amount of 30 to 40 percent by weight, based on the total weight of resin solids in the film-forming composition.

15. A coated metal substrate comprising:
A) a metal substrate having at least one coatable surface, and
B) a cured coating layer deposited on at least one surface of the substrate and having a coating/air interface and a coating/substrate interface, wherein the cured coating layer is deposited from the electrodepositable film-forming composition of claim 8; wherein the cationic acrylic resin is concentrated at the coating/air interface and the cationic resin derived from a polyepoxide is concentrated at the coating/substrate interface.

16. A process for coating an electroconductive substrate comprising the following steps:
(a) electrophoretically depositing on the substrate a curable, electrodepositable coating composition to form an electrodeposited coating over at least a portion of the substrate, the electrodepositable coating composition comprising a resinous phase dispersed in an aqueous medium, said resinous phase comprising:
(1) an ungelled active hydrogen-containing, cationic resin derived from a polyepoxide which is electrodepositable on a cathode;
(2) a cationic acrylic resin containing urethane functional groups, wherein the acrylic resin comprises (A) a reaction product of a reaction mixture comprising: (i) an acrylic resin having functional groups that are reactive with amines and (ii) a urethane functional amine compound, or the acrylic resin comprises (B) a polymerization product of a monomer mixture, wherein the monomer mixture contains an ethylenically unsaturated reaction product of a reaction mixture comprising: (i) an ethylenically unsaturated monomer having functional groups that are reactive with amines and (ii) a urethane functional amine compound; and wherein the urethane functional amine compound comprises a reaction product of a reaction mixture comprising (a) a polyamine having at least one primary amino group and at least one secondary amino group; and (b) a cyclic carbonate; and
(3) one or more at least partially blocked polyisocyanate curing agents;
(b) heating the coated substrate to a temperature and for a time sufficient to cure the electrodeposited coating on the substrate;
(c) applying directly to the cured electrodeposited coating a first coating composition to form a top coat over at least a portion of the cured electrodeposited coating;
(d) applying a second coating composition to at least a portion of the first coating formed in step (c) prior to substantially curing the first coating, to form a secondary top coat thereon;
(e) heating the coated substrate formed in step (d) to a temperature and for a time sufficient to cure all the top coats.

17. The process of claim 16, wherein the first coating composition comprises pigmented top coat.

18. The process of claim 16, wherein the second coating composition comprises a transparent top coat.

19. The process of claim 16, wherein the second coating composition comprises a pigmented top coat.
